(19) United States
(12) Patent Application Publication
(10) Pub. No.: US 2016/0369945 A1
(43) Pub. Date: Dec. 22, 2016

(54) MOUNTING DEVICE FOR HANGING ARTICLES FROM LEDGES

(71) Applicant: Charles Gerard ALCINI, Dryden, MI (US)

(72) Inventor: Charles Gerard ALCINI, Dryden, MI (US)

(21) Appl. No.: 15/185,473

(22) Filed: Jun. 17, 2016

Related U.S. Application Data
(60) Provisional application No. 62/181,956, filed on Jun. 19, 2015.

(51) Int. Cl. F16M 13/02; F16B 45/00; A47G 33/00

(52) U.S. Cl. CPC F16M 13/022; A47G 33/00; F16B 45/00

(57) ABSTRACT

A mounting device for hanging articles from overhangs and ledges is provided, whereby the heavier the article, the more secure the mounting device secures to the ledge. The mounting device includes a top arm and a bottom stabilizing arm interconnected by an arcuate portion, wherein the top and bottom stabilizing arm end in a top and a bottom portion, respectively, that securely engage the opposing top and bottom surfaces of the ledge. A top-facing hanger is disposed at an apex of the arcuate portion so that the weight of the article hanging from the hanger causes the longer bottom arm/portion to stabilize and secure the mounting device to the ledge by counterbalancing the shorter but wider top arm/portion on the opposing surfaces of the ledge.

### CROSS-REFERENCE TO RELATED APPLICATION

This application claims the benefit of priority of U.S. provisional application No. 62/181,956, filed 19 Jun. 2015, the contents of which are herein incorporated by reference.

### BACKGROUND OF THE INVENTION

The present invention relates to fasteners and, more particularly, to a mounting device for hanging articles from ledges, whereby the heavier the article, the more secure the mounting device secures to the ledge.

It is difficult to securely hang a Christmas stocking from a mantel or shelf, especially if the stocking is large or heavy. Currently available Christmas stocking holders, which employ either a small counter-weight, or a simple bent hook configuration, are not capable of securely holding the article in place on the ledge afforded by a mantel, shelf or the like. When using one of the currently available Christmas stocking holders, only very small or light stockings can be somewhat securely held. If a moderate sized or large (or heavy) stocking is attached, the device either bends, breaks, or falls off of the mantel.

As can be seen, there is a need for a mounting device for hanging articles from overhangs and ledges, whereby the heavier the article, the more secure the mounting device secures to the ledge.

### SUMMARY OF THE INVENTION

In one aspect of the present invention, a mounting device for hanging articles from overhangs and ledges includes a top portion operable to be placed on a top surface of a generally planar surface; a bottom portion operable to provide a single point of contact to a bottom surface of the generally planar surface opposite of the generally planar surface; an arcuate portion having an apex, wherein the arcuate portion interconnects the top portion and the bottom portion so that a top distance between the top portion and the apex is approximately half that of a bottom distance between the bottom portion and the apex, and wherein the arcuate portion forms a jaw-shaped curve from the top portion to the bottom portion; and a top-facing hanger provided by the arcuate portion near the apex.

In another aspect of the present invention, the mounting device further includes two spaced apart contact surfaces provided by the top portion for engaging the top surface, wherein the top portion extends transverse relative to the jaw-shaped curve, wherein each of the two spaced apart contact surfaces are rounded and, wherein a cross section of the arcuate portion has an I-beam configuration defined by an elongated body interconnecting two opposing flanges.

In yet another aspect of the present invention a method for hanging an article on a generally planar surface using the mounting device includes sliding the bottom portion along the bottom surface of the generally planar surface until the top portion engages the top surface of the generally planar surface; and hanging the article on the top-facing hanger. Wherein in certain embodiments, the generally planar surface is a mantel, and wherein the article is a Christmas stocking.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, in use;

FIG. 2 is a perspective view of an exemplary embodiment of the present invention;

FIG. 3 is a front elevation view of an exemplary embodiment of the present invention;

FIG. 4 is a cross-sectional view of an exemplary embodiment of the present invention, taken along line 4-4 of FIG. 3; and

FIG. 5 is a cross-sectional view of an exemplary embodiment of the present invention, taken along line 4-4 of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a mounting device for hanging articles from overhangs and ledges, whereby the heavier the article, the more secure the mounting device secures to the ledge. The mounting device includes a top arm and a bottom stabilizing arm interconnected by an arcuate portion, wherein the top and bottom stabilizing arm end in a top and a bottom portion, respectively, that securely engage the opposing top and bottom surfaces of the ledge. A top-facing hanger is disposed at an apex of the arcuate portion so that the weight of the article hanging from the hanger causes the longer bottom arm/portion to stabilize and secure the mounting device to the ledge by counterbalancing the shorter but wider top arm/portion on the opposing surfaces of the ledge.

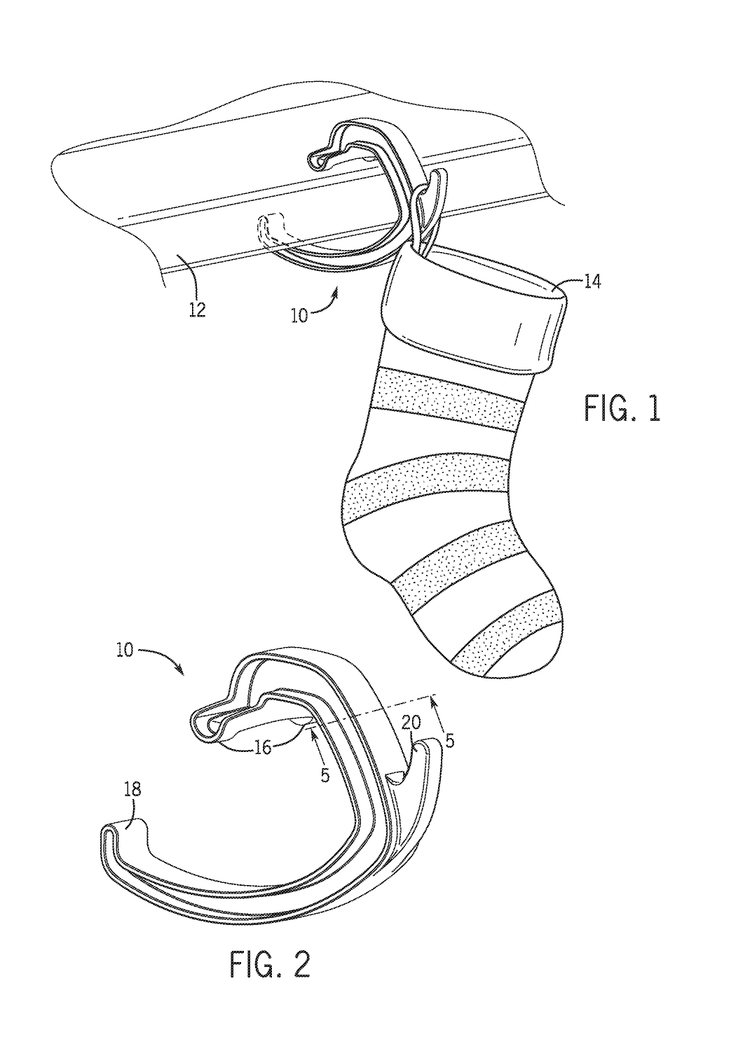

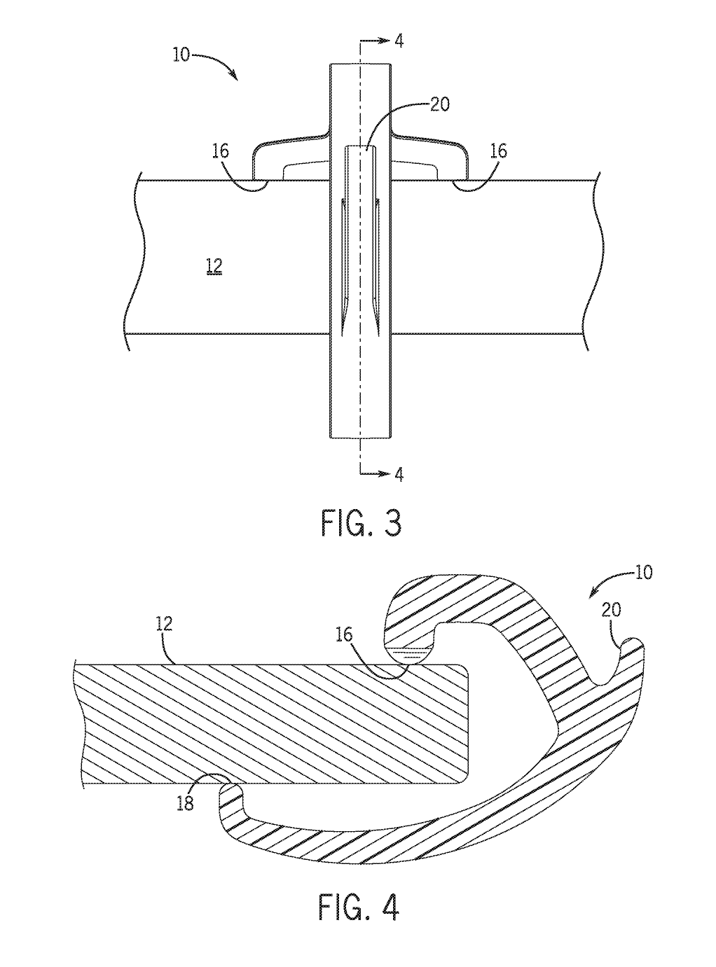

Referring to FIGS. 1 through 5, the present invention may include a mounting device 10 for securing to ledges 12 for hanging articles 14 therefrom. The ledges 12 may be an overhanging surface, such as a mantle, tabletop, shelf or the like, affording two opposing surfaces, a top surface 26 and a bottom surface 28. The mounting device 10 may be made from a material with sufficient strength to be repeatedly bent without fracture, wherein the material may be various plasticized materials that lend themselves to injection molding or additive printing. As a result, the mounting device 10 may be formed from or into a unitary construction that eliminates assembly and manufacturing burdens.

Mounting device 10 includes a top portion 16 for contacting the top surface 26, wherein the top portion 16 is provided at the distal end of a top arm 36.

Mounting device 10 includes a bottom portion 18 for contacting the bottom surface 28, wherein the bottom portion 18 is provided at the distal end of a bottom stabilizing arm 38. The proximal ends of the top and bottom stabilizing arms 36, 38 are interconnected by an arcuate portion 40. The arcuate portion 40 provides a top-facing hanger 20. It should be understood that terms using ‘top’ and ‘bottom’ (as well as related terms such as ‘up’, ‘down’, ‘lower’, ‘higher’, and their variations) are related to the aforementioned top and bottom surfaces 26, 28, which are defined in relation to the direction of gravity, directed downwardly, from the ‘top’ to the ‘bottom.’

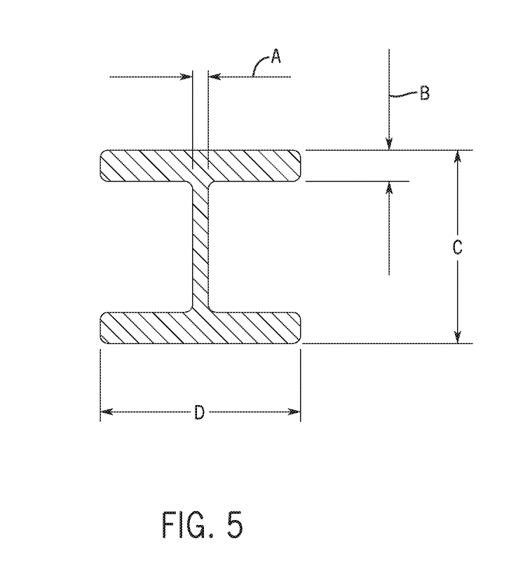

Referring to FIG. 5, the top arm 36, bottom arm 38 and the arcuate portion 40 may have a general I-shape cross section, with an elongated body interconnecting opposing flanges, thereby provide a relative high moment of inertia to resist bending with relatively little material. The elongated body—see FIG. 5—is typically 1.0 millimeter to 1.4 millimeters thick (A) and is roughly 20 millimeters high (C), while the flanges are typically 2.5 millimeter to 3.5 millimeters thick (B) and is roughly 20 millimeters wide (D). Dimensions are given in this specification for purposes of illustration and do not limit the invention to any particular set of dimensions.

The arcuate portion 40 may curve downward and away from the proximal end of the top arm 36 and then at its apex 42 changing curvature so as to curve in a direction toward the proximal end of the bottom stabilizing arm 38 (and the proximal end of the top arm 36) though continuing still downward, as illustrated in FIG. 4. The hanger 20 may be disposed near the apex 42. Other features, such as slots, for hanging the articles 14 could also be added.

The top portion 16 extends transverse to the top arm 36, as illustrated in FIG. 3. Moreover, the top portion 16 may provide a rounded contact surface 46, both these structural properties are adapted to advantageously anchor and grip as the mounting device 10 engages the top surface 26. The top portion 16 may be disposed at a lower elevation than the top arm 36. The top portion 16 may extend a “width” that is at least three times the width of the flange portion (of the top arm 36).

The bottom portion 18 is disposed at a higher elevation that its bottom stabilizing arm 38, as illustrated in FIG. 4. Furthermore, the bottom portion 18 is at a further “bottom distance” from the apex 42 as compared to a “top distance” measured from the top portion 16 to the apex 42. Geometrically, the profile of the mounting device 10—which is shown in cross-section in FIG. 4—is similar to a jaw, wherein the lower jaw extends further than the upper jaw, wherein the top and bottom portions 16 and 18 are the teeth that grip the top and bottom surfaces 26 and 28, respectively. In certain embodiments, the bottom distance is approximately 163 millimeters in length from apex 42 to a distal end of the bottom portion 18, while the top distance is approximately 95 millimeters in length. The basic configuration could be scaled up or down to accommodate a variety of ledge thicknesses, or decorating applications. Also, the design could be modified into an adaptable version, enabling the mounting device 10 to be adjusted to accommodate any size ledge 12.

This geometry enables the “lever” functionality of the mounting device 10, wherein the mass of the article 14 depending from the apex-disposed hanger 20, urges an overturning moment rotating about a top “lever arm” defined by top distance. This overturning moment is resisted and counterbalanced by the bracing resultant force where the bottom portion 18 interacts with the bottom surface 28. Note that the bottom distance extends sufficient length to counterbalance and stabilize the mounting device 10 when hanging heavy articles 14.

A method of using the present invention may include the following. The mounting device 10 disclosed above may be provided. A user may grasp the mounting device 10 at the top and bottom portions 16, 18 and then pull apart to increase the gap/space between them so approximately match the thickness of the desire ledge 12, such as a mantel, for sliding the mounting device 10 so that the top portion 16 engages a top surface 26 of the ledge 12 and the bottom portion 18 engages the bottom surface 28 of the same. Then the user may hang an article 14, such as a Christmas stocking, from the top-facing hanger 20, whereby weight of the article 14 stabilizes the mounting device 10 under the counterbalancing resulting forces at said top and bottom portions/surfaces.

It should be understood, of course, that the foregoing relates to exemplary embodiments of the invention and that modifications may be made without departing from the spirit and scope of the invention as set forth in the following claims.

What is claimed is:

1. A device, comprising:
a top portion operable to be placed on a top surface of a generally planar surface;
a bottom portion operable to provide a single point of contact to a bottom surface of the generally planar surface opposite of the generally planar surface;
an arcuate portion having an apex, wherein the arcuate portion interconnects the top portion and the bottom portion so that a top distance between the top portion and the apex is approximately half that of a bottom distance between the bottom portion and the apex, and wherein the arcuate portion forms a jaw-shaped curve from the top portion to the bottom portion; and
a top-facing hanger provided by the arcuate portion near the apex.

2. The device of claim 1, further comprising two spaced apart contact surfaces provided by the top portion for engaging the top surface.

3. The device of claim 2, wherein the top portion extends transverse relative to the jaw-shaped curve.

4. The device of claim 3, wherein each of the two spaced apart contact surfaces are rounded.

5. The device of claim 4, wherein a cross section of the arcuate portion has an I-beam configuration defined by an elongated body interconnecting two opposing flanges.

6. A method of hanging an article on a generally planar surface using the device of claim 1, comprising:
sliding the bottom portion along the bottom surface of the generally planar surface until the top portion engages the top surface of the generally planar surface; and
hanging the article on the top-facing hanger.

7. The method of claim 6, wherein the generally planar surface is a mantel, and wherein the article is a Christmas stocking.
